(19) United States
(12) Patent Application Publication
(10) Pub. No.: US 2016/0109405 A1
(43) Pub. Date: Apr. 21, 2016

(54) EXHAUST AND SEPARATION DEVICE FOR FREE-FLOW ELECTROPHORESIS APPARATUS AND METHOD FOR EXHAUSTING AIR USING THE SAME

(71) Applicant: SHANGHAI JIAO TONG UNIVERSITY, Shanghai (CN)

(72) Inventors: Chengxi CAO, Shanghai (CN); Jian YAN, Shanghai (CN); Fanzhi KONG, Shanghai (CN); Chengzhang YANG, Shanghai (CN); Liuyin FAN, Shanghai (CN)

(21) Appl. No.: 14/979,623

(22) Filed: Dec. 28, 2015

Related U.S. Application Data
(63) Continuation-in-part of application No. PCT/CN2013/084948, filed on Oct. 10, 2013.

(30) Foreign Application Priority Data
Jun. 28, 2013 (CN) 201310270077.6

(51) Int. Cl. G01N 27/447

(52) U.S. Cl. CPC G01N 27/44704; G01N 27/44769

(57) ABSTRACT

An exhaust and separation device for a free-flow electrophoresis apparatus, including a buffer reservoir, a buffer pump, a manual inflator, a gas-liquid buffering and separating member, a self-balancing recovery device, and a separation chamber. The separation chamber includes a shell including an upper cover plate, an ion-exchange membrane, and an insulating and thermal conductive base plate. The inlet of the buffer pump is connected to the buffer reservoir via a first connection pipe. The upper surface of the gas-liquid buffering and separating member is provided with an air inlet and a liquid inlet. The lower surface of the gas-liquid buffering and separating member is provided with a plurality of liquid outlets. The separation chamber is provided with buffer inlets and buffer outlets on two ends, respectively. The outlet of the buffer pump is connected to the liquid inlet of the gas-liquid buffering and separating member.

### CROSS-REFERENCE TO RELATED APPLICATIONS

This application is a continuation-in-part of International Patent Application No. PCT/CN2013/084948 with an international filing date of Oct. 10, 2013, designating the United States, now pending, and further claims priority benefits to Chinese Patent Application No. 201310270077.6 filed Jun. 28, 2013. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, and Cambridge, Mass. 02142.

### BACKGROUND OF THE INVENTION

1. Field of the Invention

The invention relates to an exhaust and separation device for a free-flow electrophoresis apparatus and a method for exhausting air using the same.

2. Description of the Related Art

Prior to the sample separation, the air in the separation chamber of a free-flow electrophoresis apparatus must be completely exhausted. To achieve the purpose, the laying angle of the separation chamber must be constantly and accurately adjusted, which is a complex process, and thus the separation efficiency thereof is very low.

### SUMMARY OF THE INVENTION

In view of the above-described problems, it is one objective of the invention to provide an exhaust and separation device for a free-flow electrophoresis apparatus and a method for exhausting air using the same. The exhaust and separation device is simple, practical, and easy to operate. By using the exhaust and separation device, air in the separation chamber is exhausted easily.

To achieve the above objective, in accordance with one embodiment of the invention, there is provided an exhaust and separation device for a free-flow electrophoresis apparatus, comprising a buffer reservoir, a buffer pump, a manual inflator, a gas-liquid buffering and separating member, a self-balancing recovery device, and a separation chamber. The separation chamber comprises a shell, the shell comprising an upper cover plate, an ion-exchange membrane, and an outer wall surface of an insulating and thermal conductive base plate. An inlet of the buffer pump is connected to the buffer reservoir via a first connection pipe. An upper surface of the gas-liquid buffering and separating member is provided with an air inlet and a liquid inlet; a lower surface of the gas-liquid buffering and separating member is provided with a plurality of liquid outlets. An inner wall of the upper cover plate, the ion-exchange membrane, and an inner wall surface of the insulating and thermal conductive base plate of the separation chamber are combined to form the separation chamber. The separation chamber is provided with buffer inlets and buffer outlets on two ends, respectively; an outlet of the buffer pump is connected to the liquid inlet of the gas-liquid buffering and separating member via a second connection pipe; an outlet of the manual inflator is connected to the air inlet of the gas-liquid buffering and separating member via a rubber hose, and the rubber hose is provided with a hose clamp. The liquid outlets of the gas-liquid buffering and separating member are connected to the buffer inlets of the separation chamber via connection pipes; the buffer outlets of the separation chamber are connected to inlets of the self-balancing recovery device.

In a class of this embodiment, the exhaust and separation device further comprises a waste recycling bottle and first three-way valves for buffer recycling. The first three-way valves are disposed on connection pipes between the buffer outlets and the self-balancing recovery device, respectively; three ports of the first three-way valves are connected to the buffer outlets, the self-balancing recovery device and the waste recycling bottle via connection pipes, respectively.

In a class of this embodiment, the exhaust and separation device further comprises a peristaltic pump and second three-way valves for air exhaust. The second three-way valves are disposed on connection pipes between the liquid outlets of the gas-liquid buffering and separating member and the buffer inlets, respectively; three ports of the second three-way valves are connected to the liquid outlets of the gas-liquid buffering and separating member, the buffer inlets and one end of the peristaltic pump via connection pipes, respectively; another end of the peristaltic pump is connected to the buffer reservoir via a connection pipe.

It is another objective of the invention to provide a method for exhausting air using the exhaust and separation device for a free-flow electrophoresis apparatus, the method comprising the following steps:

1) loosening the hose clamp, and allowing the gas-liquid buffering and separating member to communicate with the air; starting the buffer pump to pump a buffer in the buffer reservoir into the gas-liquid buffering and separating member;

2) turning off the buffer pump when a volume of the buffer in the gas-liquid buffering and separating member is more than ten times of a volume of the separation chamber, and clamping the rubber hose via the hose clamp; turning the first three-way valves to allow the separation chamber to communicate with the waste recycling bottle;

3) pumping the manual inflator quickly to inject air into a non-liquid portion of the gas-liquid buffering and separating member, the air driving the buffer in the gas-liquid buffering and separating member to enter the separation chamber, and the buffer pushing the air in the separation chamber out of the separation chamber via the buffer outlets; and collecting excess buffer by the waste recycling bottle; and

4) clamping the rubber hose via the hose clamp to isolate the gas-liquid buffering and separating member from the air.

Compared with existing technologies, advantages of the exhaust and separation device for a free-flow electrophoresis apparatus and a method for exhausting air using the same are as follows: the device features a proper design and is easy to operate; the exhaust device is able to effectively and quickly exhaust air in the separation chamber; and the device of the invention has low cost.

### BRIEF DESCRIPTION OF THE DRAWINGS

FIG. 1 is a schematic diagram of an exhaust and separation device for a free-flow electrophoresis apparatus in example 1;

FIG. 2 is a schematic diagram of an exhaust and separation device for a free-flow electrophoresis apparatus in example 2;

FIG. 3 is a schematic diagram of a longitudinal section of a separation chamber in accordance with one embodiment of the invention;

FIGS. 4A-4C are a three-dimensional graph, a front view, and a side view of a gas-liquid buffering and separating member, respectively, in accordance with one embodiment of the invention;

In the figures, the following reference numbers are used: 1. Manual inflator; 2. Buffer pump; 3. Buffer reservoir; 4. Gas-liquid buffering and separating member; 5. Waste recycling bottle; 6. First three-way valves; 7. Self-balancing recovery device; 8. Shell of separation chamber; 9. Buffer inlets; 10. Buffer outlets; 11. Hose clamp; 12. Rubber clamp; 13. Upper cover of separation chamber; 14. Ion-exchange membrane; 15. Insulating and thermal conductive base plate; 16. Separation chamber; 17. Air inlet of gas-liquid buffering and separating member; 18. Liquid inlet of gas-liquid buffering and separating member; 19. Liquid outlets of gas-liquid buffering and separating member; 20. Peristaltic pump; and 21. Second three-way valves.

### DETAILED DESCRIPTION OF THE EMBODIMENTS

For further illustrating the invention, experiments detailing an exhaust and separation device for a free-flow electrophoresis apparatus and a method for exhausting air using the same are described below. It should be noted that the following examples are intended to describe and not to limit the invention.

### EXAMPLE 1

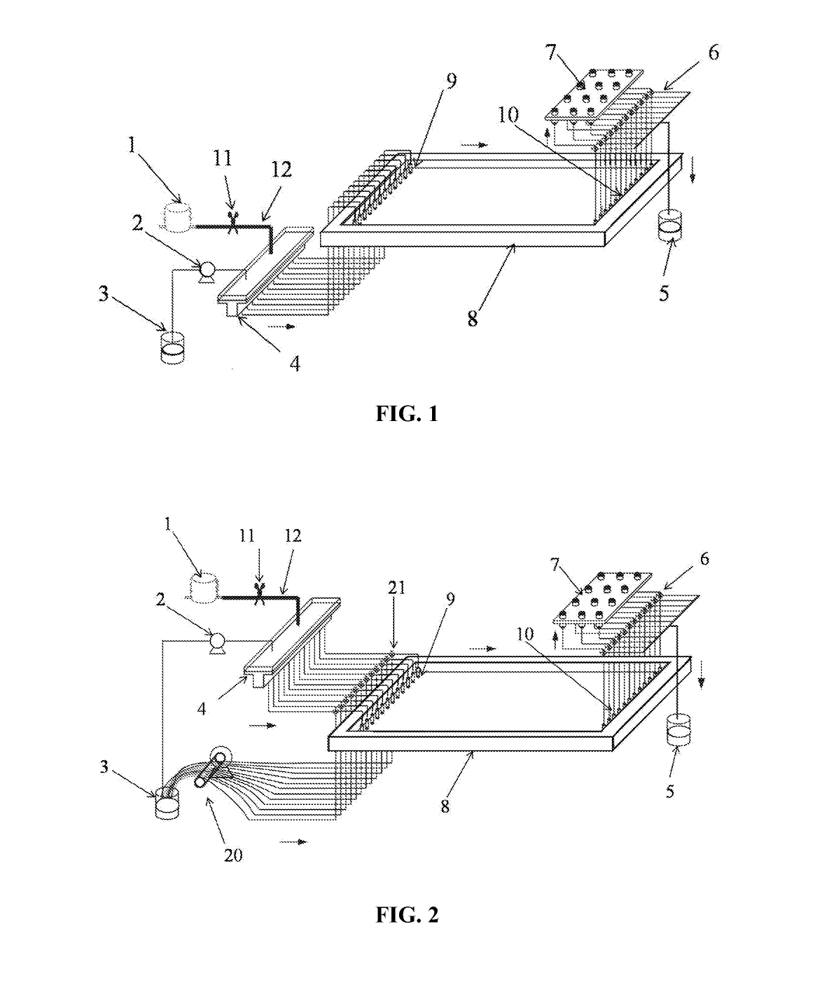

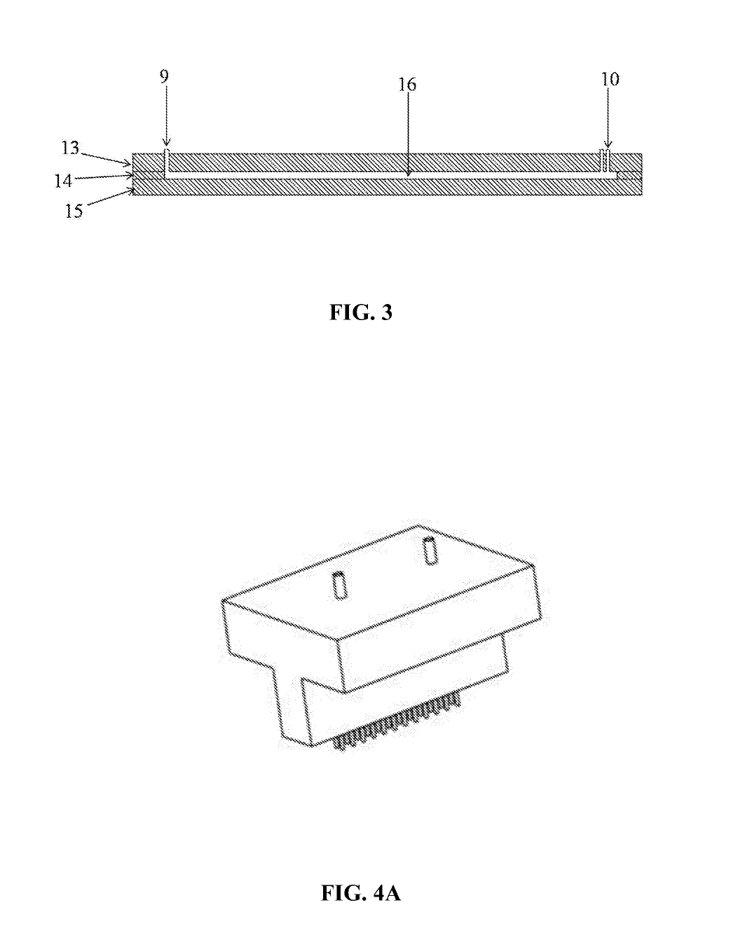

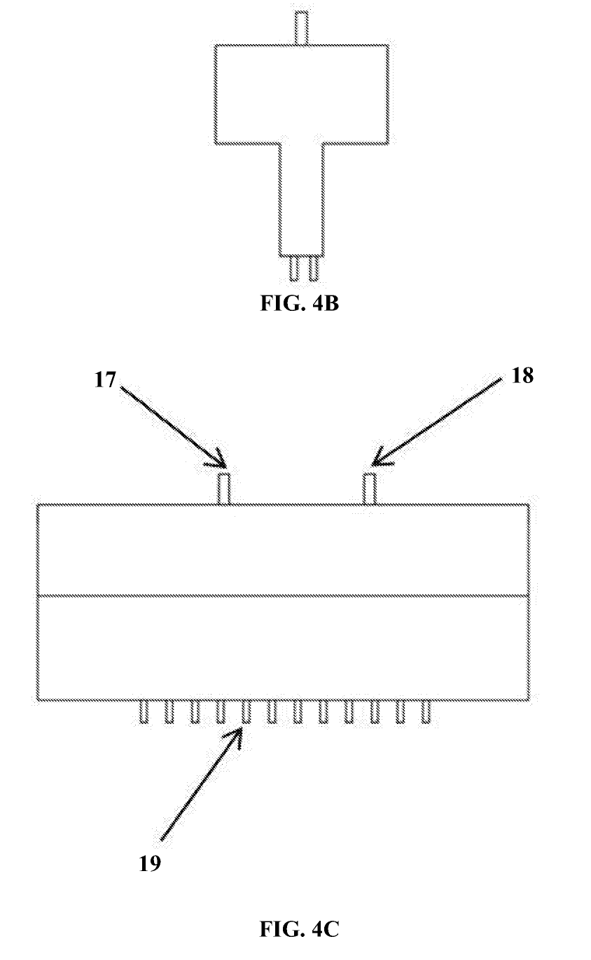

As shown in FIGS. 1, 3 and 4A-4C, an exhaust and separation device for a free-flow electrophoresis apparatus comprises a buffer reservoir 3, a buffer pump 2, a manual inflator 1, a hose clamp 11, a rubber hose 12, a gas-liquid buffering and separating member 4, a self-balancing recovery device 7, a separation chamber shell 8, a separation chamber 16, a waste recycling bottle 5, and first three-way valves 6. An inlet of the buffer pump 2 is connected to the buffer reservoir 3 via a connection pipe. An upper surface of the gas-liquid buffering and separating member 4 is provided with an air inlet 17 and a liquid inlet 18. A lower surface of the gas-liquid buffering and separating member 4 is provided with a plurality of liquid outlets 19. The separation chamber shell 8 comprises an upper cover plate 13, an ion-exchange membrane 14, and an outer wall surface of an insulating and thermal conductive base plate 15. The inner wall of the upper cover plate 13, the ion-exchange membrane 14, and an inner wall surface of the insulating and thermal conductive base plate 15 are combined to form the separation chamber 16.

The separation chamber 16 is provided with buffer inlets 9 and buffer outlets 10 on two ends, respectively. An outlet of the buffer pump 2 is connected to the liquid inlet 18 of the gas-liquid buffering and separating member via a second connection pipe. An outlet of the manual inflator 1 is connected to the air inlet 17 of the gas-liquid buffering and separating member via the rubber hose 12, and the hose clamp 11 is disposed on the rubber hose 12. The liquid outlets 19 of the gas-liquid buffering and separating member are connected to the buffer inlets 9 via connection pipes. The buffer outlets 10 are connected to inlets of the self-balancing recovery device 7. Connection pipes between the buffer outlets 10 and the self-balancing recovery device 7 are provided with first three-way valves 6. Three ports of the first three-way valves 6 are connected to the buffer outlets 10, the self-balancing recovery device 7 and the waste recycling bottle 5 via connection pipes, respectively.

In practice, the hose clamp 11 is loosened during air exhaust, and the buffer pump 2 is started. The buffer pump 2 is closed when a volume of the buffer in the gas-liquid buffering and separating member is more than ten times of a volume of the separation chamber 16, then the first three-way valves 6 are turned to enable the separation chamber 16 to communicate with the waste recycling bottle 5. The manual inflator 1 is pumped quickly to inject liquid in the gas-liquid buffering and separating member 4 into the separation chamber 16 to exhaust air. When small bubbles remain in the separation chamber 16, the manual inflator 1 is quickly and slightly pumped so that running buffer takes the bubbles away.

### EXAMPLE 2

As shown in FIG. 2, an exhaust and separation device for a free-flow electrophoresis apparatus comprises a buffer reservoir 3, a buffer pump 2, a manual inflator 1, a hose clamp 11, a rubber hose 12, a gas-liquid buffering and separating member 4, a self-balancing recovery device 7, a separation chamber shell 8, a separation chamber 16, a waste recycling bottle 5, first three-way valves 6 for buffer recycling, a peristaltic pump 20, and second three-way valves 21 for air exhaust. Connection pipes between the liquid outlets 19 of the gas-liquid buffering and separating member and the buffer inlets 9 are provided with the second three-way valves 21 for air exhaust. Three ports of the second three-way valves 21 are connected to the liquid outlets 19 of the gas-liquid buffering and separating member, the buffer inlets 9 and one end of the peristaltic pump 20 via connection pipes, respectively. Another end of the peristaltic pump 20 is connected to the buffer reservoir 3 via a connection pipe.

In practice, the liquid outlets 19 of the gas-liquid buffering and separating member 4 are separated from the separation chamber 16 as the second three-way valves 21 turn, then the hose clamp 11 is opened, and the buffer pump 2 is started to add buffer into the gas-liquid buffering and separating member. The buffer pump 2 is closed until a volume of the buffer is more than ten times of a volume of the separation chamber 16. Then the peristaltic pump 20 is started to fill the connection pipes with the buffer. The peristaltic pump 20 is stopped when the buffer appears at the buffer inlets 9 of the separation chamber 16. The first three-way valves 6 are turned to enable the separation chamber 16 to communicate with the waste recycling bottle 5. The second three-way valves 21 are turned to enable the gas-liquid buffering and separating member 4 to communicate with the separation chamber 16. Finally, the manual inflator 1 is pumped quickly to inject the buffer in the gas-liquid buffering and separating member 4 into the separation chamber 16 to exhaust air.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An exhaust and separation device for a free-flow electrophoresis apparatus, the device comprising:
a) a buffer reservoir;
b) a buffer pump, the buffer pump comprising an inlet;
c) a manual inflator;
d) a gas-liquid buffering and separating member;
e) a separation chamber, the separation chamber comprising a shell, the shell comprising an upper cover plate, an ion-exchange membrane, and an outer wall surface of an insulating and thermal conductive base plate; and
f) a self-balancing recovery device;
wherein
the inlet of the buffer pump is connected to the buffer reservoir via a first connection pipe;
an upper surface of the gas-liquid buffering and separating member is provided with an air inlet and a liquid inlet; a lower surface of the gas-liquid buffering and separating member is provided with a plurality of liquid outlets;
an inner wall of the upper cover plate, the ion-exchange membrane, and an inner wall surface of the insulating and thermal conductive base plate are combined to form the separation chamber;
the separation chamber is provided with buffer inlets and buffer outlets on two ends, respectively; an outlet of the buffer pump is connected to the liquid inlet of the gas-liquid buffering and separating member via a second connection pipe; an outlet of the manual inflator is connected to the air inlet of the gas-liquid buffering and separating member via a rubber hose, and the rubber hose is provided with a hose clamp; and
the liquid outlets of the gas-liquid buffering and separating member are connected to the buffer inlets of the separation chamber via connection pipes; the buffer outlets of the separation chamber are connected to inlets of the self-balancing recovery device.

2. The device of claim 1, further comprising a waste recycling bottle and first three-way valves for buffer recycling; wherein the first three-way valves are disposed on connection pipes between the buffer outlets and the self-balancing recovery device, respectively; three ports of the first three-way valves are connected to the buffer outlets, the self-balancing recovery device and the waste recycling bottle via connection pipes, respectively.

3. The device of claim 1, further comprising a peristaltic pump, and second three-way valves for air exhaust; wherein the second three-way valves are disposed on connection pipes between the liquid outlets of the gas-liquid buffering and separating member and the buffer inlets, respectively; three ports of the second three-way valves are connected to the liquid outlets of the gas-liquid buffering and separating member, the buffer inlets and one end of the peristaltic pump via connection pipes, respectively; another end of the peristaltic pump is connected to the buffer reservoir via a connection pipe.

4. A method for exhausting air using the exhaust and separation device for a free-flow electrophoresis apparatus of claim 2, the method comprising:
1) loosening the hose clamp, and allowing the gas-liquid buffering and separating member to communicate with the air; starting the buffer pump to pump a buffer in the buffer reservoir into the gas-liquid buffering and separating member;
2) turning off the buffer pump when a volume of the buffer in the gas-liquid buffering and separating member is more than ten times of a volume of the separation chamber, and clamping the rubber hose via the hose clamp; turning the first three-way valves to allow the separation chamber to communicate with the waste recycling bottle;
3) pumping the manual inflator quickly to inject air into a non-liquid portion of the gas-liquid buffering and separating member, the air driving the buffer in the gas-liquid buffering and separating member to enter the separation chamber, and the buffer pushing the air in the separation chamber out of the separation chamber via the buffer outlets; and collecting excess buffer by the waste recycling bottle; and
4) clamping the rubber hose via the hose clamp to isolate the gas-liquid buffering and separating member from the air.
